(19) United States
(12) Patent Application Publication
(10) Pub. No.: US 2006/0063694 A1
(43) Pub. Date: Mar. 23, 2006

(54) Composition for reducing flow-resistance of hot water and process for reducting flow-resistance of hot water using the same

(76) Inventors: Seong-Hwan Cho, Daejeon (KR); Chun-Sub Tae, Daejeon (KR); Hyeong-Rok Kim, Daejeon (KR); Seung-Bum Kim, Daejeon (KR); Yong-Joo Seo, Incheon (KR); Min-Chul Hong, Incheon (KR)

Correspondence Address: CANTOR COLBURN LLP, 55 Griffin Road South, Bloomfield, CT, 06002, US

(21) Appl. No.: 11/117,827

(22) Filed: Apr. 29, 2005

(30) Foreign Application Priority Data
Sep. 22, 2004 (KR) 2004-76096

(51) Int. Cl. C11D 1/75

(52) U.S. Cl. 510/503

(57) ABSTRACT

Disclosed are a composition for reducing flow-resistance of hot water in a tubular container principally comprising a combination of surfactant component and micelle structure stabilizer component in which the surfactant component can form linear micelles and the stabilizer component can stabilize structure of the micelle formed, and a process for efficiently reducing flow-resistance of hot water using said composition. Accordingly, the present invention provides the composition for reducing flow-resistance of hot water in the tubular container produced combining alkylamine oxide based surfactant and, optionally, a secondary surfactant, with various amino acids as the micelle structure stabilizer, so that it can maintain in water area at high temperature ranged from 50 to 100° C. and provide efficiency for 50% or more reduction of flow-resistance of turbulent flow in the tubular container.

This U.S. non-provisional patent application claims priority under 35 U.S.C. § 119 of Korean Patent Application 2004-76096 filed on Sep. 22, 2004, the entire contents of which are hereby incorporated by reference.

### BACKGROUND OF THE INVENTION

1. Field of the Invention

The present invention relates to compositions useful for reducing flow-resistance of hot water in tubular container and processes capable of efficiently reducing flow-resistance of hot water using the same. More particularly, the present invention relates to a composition for reducing flow-resistance of hot water which is used to reduce the flow-resistance of hot water contained in the tubular container necessarily generated when the hot water at 50 to 100° C. flows in the tubular container to transfer heat energy, comprising a surfactant and a structure stabilizer to make the structure of micelle generated from the surfactant to be stable, and a process for reducing flow-resistance of hot water in the tubular container which is used to efficiently reduce the flow-resistance in the tubular container using the above composition.

2. Description of Related Art

Generally, it is well known that when heat energy is transferred using water, amount of the energy consumed in movement of water in a tubular container reaches up to 30% based on total amount of heat energy to be transferred and, in case the water movement becomes longer, consumption rate of the heat energy is higher. For this reason, techniques for reducing flow-resistance become more important in technical fields necessary for efficiently transferring and using heat energy.

A variety of techniques have been investigated and studied in applications for reducing flow-resistance of turbulent fluid in tubular containers useful for water system. As a result, it makes an advance in such techniques including, for example, addition of water-soluble polymeric materials to fire-fighting water to lower the flow-resistance in the tubular container and increase spraying distance using the same injection power when the fire-fighting water is injected, production of linear micelles as a voluntary combination of specific surfactants having a structure similar to secondary structure of the water-soluble polymeric material mentioned above in water-based fluids thereby resulting in reduction of flow-resistance of the turbulent fluid, etc.

In recent years, it extensively and intensively proceeds research and development in related applications such as alkyl ammonium based compositions for reducing flow-resistance mainly comprising long chain alkyl ammonium components as a principal component of micelle formation expressing 70% or more of excellent efficiency for reducing flow-resistance. However, such alkyl ammonium based compositions has a serious toxicity to soil bacteria due to alkyl ammonium component contained in the compositions and accident effluence thereof to cause impact harmful to environment, thus, its practical use is held in abeyance. Accordingly, it tends to strongly require development of flow-resistance reduction compounds comprising environment-friendly components with very little or substantially no toxicity as a principle component to ensure practical application thereof.

Key point of theoretical principles in relation to flow-resistance reduction techniques is based on flow phenomenon of fluid, so called Tom's effect. Such effect means that, in case about 0.1% surfactants or water-soluble polymers are coagulated together or spontaneously crossed together to form a fibrous combination with a length of about 100 μm in aqueous solution, the combination increases viscoelasticity of fluid by effecting turbulent flow condition of the fluid and reduces the flow-resistance by altering inherent property of the turbulent fluid, thereby resulting in transfer of fluid in the same amount at unit time using relatively low transfer energy.

Although some of the surfactants possible to form a few of water-soluble polymers and linear micelles are appraised as materials expressing Tom's effect, only the surfactant materials are selectively applied in development of techniques for control of components contained in flow-resistance reduction compounds in circulation system. This is because structures of polymeric materials are irreversibly broken not to retain Tom's effect in the circulation system, while structure of the linear micelle can be spontaneously restored to its original condition in short time even if the structure naturally generated from surfactant molecules is temporally destructed by different shear forces, heat, chemical effects generated during transfer of water.

Therefore, in fields for using the flow-resistance reduction effect in the water circulation system, important subjects under investigation are structural stability of linear micelles at high temperature and for long time to as well as critical factors such as environmental affinity of the surfactant, low toxicity, low cost, simple disposal after use, etc.

One of component combinations widely known to be effective as the water flow-resistance reduction compound is a mixed component system of alkylammonium and salicylate. Herein, alkylammonium based surfactant is a micelle formation agent while salicylate can be classified as a high temperature stability enhancer. Among the mixed component systems, a component combination of cetyltrimethyl ammonium and sodium salicylate or naphthol is well known as a representative flow-resistance reduction agent (J. Non-Newtonian Fluid Mech. 97, 151-266 (2001)). Such alkylammonium component combination system has low environmental affinity and is excluded from practical application due to worry about load to environment, however, is employed as a reference material in a stage such as learning study for effect of the flow-resistance reduction and comparison of performance of the combination system.

As mentioned above, there are various studying approaches to overcome defect of applicability caused by lack of environmental affinity of such representative components to form flow-resistance reduction compounds. More particularly, a combination of amine oxide based surfactants and cationic surfactant, for example, sodium dodecylbenzene sulfonate and a combination of betaine based surfactant and sodium dodecylbenzene sulfonate are under investigation as components of a water based flow-resistance reduction compound having improved applicability (JAOCS 73, 7.91-928 (1996) ). Japanese Patent Laid-Open No. H11-29758 disclosed a composition which comprises a surfactant having amine oxide bonded with alkyl group for main skeleton thereof as a component of the water based compound useful for flow-resistance reduction over from low temperature to high temperature, as a principal component; and an additional non-ionic water-soluble material having ethylene oxide or ethylene oxide oligomer component with substituent. Such composition also includes the amine oxide based surfactant having lower environmental load. The above document proposed a technique to use complementary surfactant containing non-ionic polyethylene oxide component with low toxicity.

Japanese Patent Laid-Open No. H11-61093 disclosed a water based friction-resistance reduction composition which comprises a principal component, surfactant having quaternary imidazolium cationic skeleton as hydrophilic part; and a non-ionic polyethylene oxide based additive. Likewise, Japanese Patent Laid-Open No. H11-193373 disclosed a water based friction-resistance reduction composition which comprises alkyl glucamide component with low environmental load and toxicity as its principal component.

Japanese Patent Laid-Open No. 2000-313872 disclosed that it is possible to form micelles within 1.0% by weight ratio and to reduce friction-resistance in water system tubular container using a combination of at least two ampholytic surfactants, or using specified anionic surfactant and non-ionic surfactant singly or in combination of two or more thereof. Such combination comprises principally a material capable of forming positive charge distribution in N+- X-form adapted for a main surfactant in consideration of environmental affinity and low toxicity. Such properties can strongly depends on chemical structure of neighborhood of the N+- X-form positive charge distribution. It was also proposed a technique for mixing and applying specified anionic and non-ionic surfactants to complement the above properties.

It will be understood that the above representative techniques relating flow-resistance reduction compounds are based on chemical composition of the compounds and technical arts to combine components in the compounds in desired composition ratio. For example, the flow-resistance reduction compounds containing alkylammonium based surfactants represent excellent efficiency for reducing the flow-resistance but have high toxicity, thereby being substantially not mentioned in recent applications for composition of such flow-resistance reduction composition. Therefore, it takes an intensive interest at present in studying low toxicity ampholytic surfactants and non-ionic surfactants in replace of such alkylammonium based surfactants. In addition, it is now under the stage to employ additive materials with different types of surfactant complementary in various ways to enhance relatively low flow-resistance efficiency and low stability of such surfactants. Consequently, important points in this application are to maintain flow-resistant effect without destruction of micelles formed of surfactants principally employed at high temperature, to lower toxicity of the surfactant used, and whether it provides flow-resistance reduction effect possible to retain features and physical properties of other components classified as micelle structure stabilizers corresponding to those of the main surfactants.

Accordingly, as a result of extensive researches in view of objects to use the surfactants having low toxicity and small load to environment as the main component, to combine specified micelle structure stabilizer in the surfactants for purpose of making up for insufficient capability to form and maintain linear micelles of such surfactants, to analyze and evaluate combined flow-resistance effect by a combination of such structure and components of the surfactants and to ensure desirable components and composition ratio thereof of optimum water based composition for reducing flow-resistance, the inventors have completed the present invention.

### SUMMARY OF THE INVENTION

The present invention provides a composition for reducing flow-resistance of hot water comprising environment-friendly surfactant and micelle structure stabilizer which can retain stability of the micelle even at high temperature equal to 90° C. or more as a target temperature in fields for high temperature flow-resistance reduction in water system and express the flow-resistance reduction effect.

The present invention also provides a process for reducing flow-resistance of hot water to efficiently reduce flow-resistance of the hot water in a tubular container using the composition mentioned above.

In order to accomplish the above objects, the present invention provides a composition for reducing flow-resistance of hot water comprising alkylamine oxide based surfactant and amino acid based structure stabilizer to stabilize structure of micelle produced from the above surfactant.

The present invention also provides a composition for reducing flow-resistance of hot water comprising: alkylamine oxide based surfactant and a secondary surfactant not generating precipitate by combination with the alkylamine oxide based surfactant.

The present invention also provides a process for reducing flow-resistance of hot water comprising: introducing the above composition in a concentration ranged from 200 to 5000 ppm in hot circulation water at a temperature ranged from 50 to 100° C. and circulating the mixed water.

The composition for reducing flow-resistance of hot water and the process for reducing flow-resistance of hot water using the same will be describe in detail with reference to the following description.

The composition according to the present invention comprises an alkylamine oxide based surfactant and the amino acid based structure stabilizer to stabilize structure of the micelle produced from the above surfactant.

The alkylamine oxide based surfactant preferably includes one selected from specified compounds represented by the following formula 1:

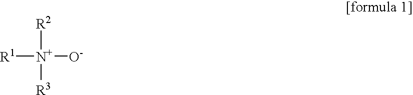

wherein R¹ is alkyl group having 12 to 22 carbon atoms, and R² and R³ which are same or different are selected from a group consisting of —H, CH₃ and —(CH₂—CH₃—O)ₙ—H wherein n is 1 to 3.

The environmental-friendly alkylamin oxide based surfactant represented by the above formula 1 includes any selected from a group consisting of lauryldimethyl amine oxide, myristyldimethyl amine oxide, palmityldimethyl amine oxide, stearyldimethyl amine oxide, arachyldimethyl amine oxide, biphenyldimethyl amine oxide, N,N-diethoxylauryl amine oxide, N,N-diethoxymyristyl amine oxide, N,N-diethoxypalmityl amine oxide, N,N-diethoxystearyl amine oxide, N,N-diethoxyarythyl amine oxide or N,N-diethoxybihenyl amine oxide. These compounds may be used singly or in combination of two or more, with stearyldimethyl amine oxide being more preferred.

Amino acid based structure stabilizer is for ensuring thermal stability of linear micelles formed by the above alkylamine oxide based surfactant, has excellent biodegradable ability and is safe and applicable to living body without toxicity so that it is widely used in medicine, additive for stock feed, components in chemical seasonings. This stabilizer has combined cationic and anionic property, that is, ampholytic property to stabilize structure of the micelles.

The above amino acid based structure stabilizer is preferably selected from compounds represented by the following formula 2:
R⁴—(CH₂)ₘ—COOH [formula 2]

wherein R⁴ is alkyl or allyl group bonded with amino functional group (—NH₂) having 1 to 5 carbon atoms, and m is integer ranged from 0 to 5.

More preferably, examples of the amino acid based compounds represented by the above formula 2 include glycine, alanine, valine, leucine, isoleucine, threonine, serine, cysteine, cystine, methionine, aspartic acid, asparagine, glutamic acid, diodide tyrosine, lysine, arginine, histidine, phenylalanine, tyrosine, tryptophan, proline, oxyproline, α-alanine, -aminobutyric acid, ornithine, citrulline, homoserine, triiodide tyrosine, thyroxine, dioxyphenylalanine, etc. These compounds may be used singly or in combination of two or more. In addition, amino acid mixture produced after hydrolysis of various proteins can be applied with purification or directly without purification. Most preferably, the amino acid based compounds with the above formula 2 is selected from alanine, glutamine or glycine.

The amino acid based compounds useable as the above structure stabilizer can increase the flow-resistance reduction effect compared with the compounds using the surfactant for a purpose of flow-resistance reduction and, in addition to, enlarge temperature range expressing the flow-resistance reduction effect up to 100° C. or more.

Herein, in spite of important role of the amino acid based structure stabilizer, content ratio of the stabilizer to the surfactant needs to control. The structure stabilizer made of the amino acid based compound is contained in an amount of 1 to 100 parts by weight based on 100 parts by weight of the alkylamine oxide based surfactant. If the amount is less than 1 part by weight, the stabilizer can express substantially little effect of the flow-resistance reduction or express the effect only at lower temperature equal to 60° C. or less, thereby having no practical usability. If the amount exceeds 100 parts by weight, it may generate precipitate of the amino acid used as the structure stabilizer and, on the contrary, reduce the flow-resistance reduction effect. Accordingly, both of the surfactant and the structure stabilizer are preferably included in the range of amount described above, and with 1 to 50 parts by weight of the structure stabilizer based on 100 parts by weight of the surfactant being more preferred.

According to the present invention, by additionally adding a variety of the secondary surfactants friendly to environment other than the alkylamine oxided based surfactant, it is possible to extend range of a surfactant constructional combination useful in formation of linear micelles. Such secondary surfactants can comprise environment-friendly compounds not to precipitate thereof together with alkylamine oxide.

Particularly, the secondary surfactant optionally used in the present invention can express the effect to increase structure stability, compared with using only the amine oxide based surfactant. A combination of different surfactants can generally complement electrical and structural defects of micelles generated using one type of the surfactant alone. That is, the combination of different surfactants can increase stability of micelles and ensure thermal stability for long time. For example, when part of alkylamine oxide component only is combined with amino acid to produce a compound for reduction of flow-resistance at high temperature, the compound has low stability possible to express low reduction of flow-resistance. Such condition can be eliminated by adding the secondary complementary surfactant in a desired amount.

Based on such effect, the secondary surfactant may be optionally used to increase the structural thermal stability and preferably added in an amount of 100 parts by weight or less and, more preferably 50 parts by weight or less based on 100 parts by weight of the alkylamine oxide based surfactant.

Examples of the useable, secondary surfactant include alkyl polyglucoside ester, polyoxyethylene sorbitane monolaurate, polyoxyethylene sorbitane monostearate, polyoxyethylene sorbitane monooleate, polyoxyethylene sorbitane trilaurate, polyoxyethylene sorbitane tristearate, polyoxyethylene sorbitane trioleate, polyoxyethylene methylglucoside ester, cocoamidopropyl betaine, laurylamidopropyl betaine, disodium lauryl amphodiacetate, disodium cocoamphodiacetate, methyl-1-oleylamide ethyl-3-oleylimidazolium methylsulfate, bis(acyloxyethyl)hydroxyethyl ammonium methosulfate lauryldimethyl betaine, myristyldimethyl betaine, palmityldimethyl betaine, stearyldimethyl betaine, arythyldimethyl betaine, biphenyldimethyl betaine being used singly or in combination of two or more. Betaine based environment-friendly surfactants are optionally and preferably used.

In this case, in order to more stabilize the micelles produced, the composition for reducing the flow-resistance of the hot water according to the present invention may be applied in a small amount, other than the surfactant and the stabilizer for structure of the micelles. In particular, preferably employed are chemicals preventing deterioration or corruption of additional organic materials, antioxidant inhibiting oxidation and ageing, corruption-inhibitor, etc in desired ranges of amount for typical use. Also, if hydrogenion concentrations, that is, pH values of the amino acid containing aqueous solution are greatly out of the neutral level, adding slight amount of acidic or basic materials to regulate pH values of the solution near to the neutral level can inhibit corrosion of the tubular container and, at the same time, contribute maintenance of the flow-resistance reduction effect.

As described above, the composition for reducing flow-resistance of hot water according to the present invention comprising the alkylamine oxide based surfactant and amino acid based structure stabilizer and, optionally, the secondary surfactant is environment-friendly and helpful for retaining stability of micelles even at high temperature of 90° C. or more as the target in the technical fields relating flow-resistance reduction in water system.

With respect of the present invention, it provides a process for reducing flow-resistance of hot water to sufficiently express the flow-resistance using the above composition. More particularly, the process comprises adding the composition for reducing flow-resistance in the concentration ranged from 200 to 5000 ppm in hot circulation water in a tubular container then circulating the mixture.

In this case, if the concentration of the composition is less than 200 ppm, it may cause a problem that the composition has little or no flow-resistance reduction effect since the circulation mixture has very low concentration of surfactant component and fails to reach minimum concentration required to form micelles(CMC). When the concentration exceeds 5000 ppm, linear micelles become increasing or longer in dimension to lead precipitation during use or coagulated together to form gel type materials having highest viscosity, thereby resulting in worry about rather increasing of flow-resistance. Accordingly, the present inventive composition for reducing flow-resistance is preferably added to the circulation water in the concentration ranged from 200 to 5000 ppm.

If the composition is added to the circulation water within such range of amount, excellent effect of the flow-resistance reduction during the circulation of hot water at 50 to 100° C. in the tubular container can be accomplished and, particularly, stability of the micelles can be maintained event at high temperature equal to 90° C. or more as the target temperature in the technical fields relating the flow-resistance reduction of hot water.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic view illustrating an installation for determining flow-resistance reduction effect of water;

FIG. 2 is a graph illustrating results of the flow-resistance reduction of circulation water dependent on variation of temperature; and

FIG. 3 is a graph illustrating results of the flow-resistance reduction of circulation water dependent on variation of amino acids used.

### DETAILED DESCRIPTION OF THE INVENTION

Hereinafter, the present invention will be described in detail by way of examples for, which should not be construed as limiting the invention thereto.

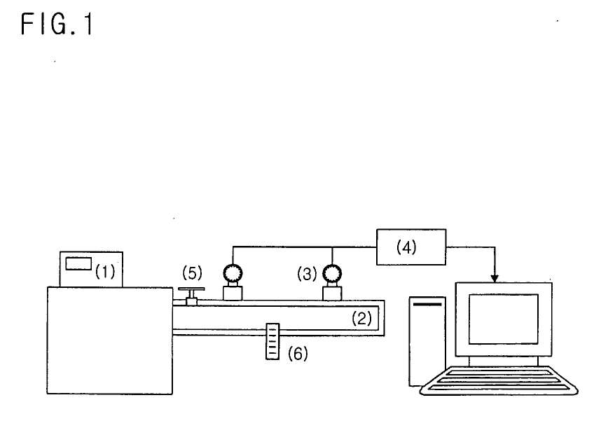

In order to evaluate the composition for reducing flow-resistance of hot water according to the present invention and performance thereof dependent on applications in quantitative ways, an installation for determining flow-resistance as shown in FIG. 1 is used.

The installation comprises a power device 1 to continuously circulate 15L water, a water circulation duct 2, a pressure measurement device 3 to measure pressure of water, a control device 4 to compare alteration of pressure, a valve device 5 to regulate flow rate of water and a flow meter 6.

Circulation velocity of water in the tubular container can be regulated in a range of 0.0 to 5.0 m/second while controlling temperature of water within a range of 0 to 100° C. by 0.1° C. scale. After charging pure water in the installation, added is desirable amount of a flow-resistance reduction compound while keeping constant temperature and velocity. By measuring alteration of pressure between two points in the circulation state, the flow-resistance reduction effect can be quantitatively determined. That is, flow-resistance reduction effect (DR effect) can be determined by a procedure which comprises measuring a pressure difference ΔPw between two pressure measurement points in flow of the pure water, measuring another pressure difference ΔPd between two pressure measurement points in flow of the water added with the flow-resistance reduction compound at the same temperature and flow rate, then calculating a difference between them (that is, ΔPw and ΔPd) by the following equation 1.

$$\text{Flow-resistance reduction effect} ( DR \text{effect} ) ( \% ) = \frac{Δ pw - Δ pd}{Δ pw} \times 100 \qquad [ Equation 1 \}$$

### EXAMPLE 1

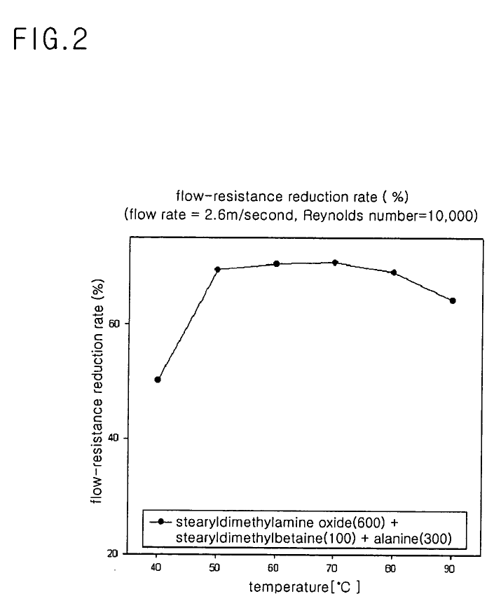

In the installation for measurement of flow-resistance reduction effect as shown in FIG. 1 charged with 15L pure water, added is a combined composition comprising N,N-dimethylstearylamine oxide, N,N-dimethylstearyldimethyl betaine and DL-alanine while keeping temperature of the pure water at 40° C. Then, the mixture circulates from the installation into a tubular container at a circulation rate of 3 m/second for 30 minutes to be completely blended. Herein, respective concentrations of the circulated water are shown in the following Table 1. After 30 minutes, controlling the circulation rate of the water into 2.6 m/second at 40° C. and measuring the pressures at two pressure measurement points, then, determined is the pressure difference ΔPd. After charging the pure water, determined is also the pressure difference ΔPw by measuring the pressures at two pressure measurement points in the same manner described above at the same condition of temperature and circulation rate. From results obtained, the flow-resistance reduction effect is estimated utilizing the above equation 1. With alteration of the water temperature into 50° C., 60° C., 70° C., 80° C. and 90° C. respectively, the pressure difference between two points was measured at the respective temperatures in the same manner described above. Further, the above measurement conditions and measured values corresponding thereto were illustrated in Table 1. In addition, the flow-resistance reduction effect for this case was illustrated in FIG. 2.

### EXAMPLES 2 AND 3

The procedure of Example 1 was repeated except that respective concentrations of N,N-dimethylstearylamine oxide, N,N-dimethylstearyldimethyl betaine and DL-alanine were regulated as shown in Table 1, to thereby obtain the flow-resistance reduction effect. The results are shown in the following Table 1.

TABLE 1

| | First | Secondary | | Temperature | | | Flow- |
|---|---|---|---|---|---|---|---|
| | surfactant | surfactant | Stabilizer | (° C.)/flow | | | resistance |
| | (ppm | (ppm | (ppm | rate | ΔPw | ΔPd | reduction |
| Classification | concentration) | concentration) | concentration) | (m/second) | (kPa | (kPa) | effect(%) |
| Example 1 | Stearyldimethylamine | Stearyldimethyl | Alanine | 50/2.6 | 14.78 | 4.62 | 68.7 |
| | oxide(600) | betaine(100) | (300) | | | | |
| | Stearyldimethylamine | Stearyldimethyl | Alanine | 60/2.6 | 14.91 | 4.19 | 71.9 |
| | oxide(600) | betaine(100) | (300) | | | | |
| | Stearyldimethylamine | Stearyldimethyl | Alanine | 70/2.6 | 15.08 | 4.08 | 72.9 |
| | oxide(600) | betaine(100) | (300) | | | | |
| | Stearyldimethylamine | Stearyldimethyl | Alanine | 80/2.6 | 15.34 | 4.68 | 69.5 |
| | oxide(600) | betaine(100) | (300) | | | | |
| | Stearyldimethylamine | Stearyldimethyl | Alanine | 90/2.6 | 15.52 | 5.22 | 66.4 |
| | oxide(600) | betaine | (300) | | | | |
| | | (100) | | | | | |
| Example 2 | Stearyldimethylamine | Stearyldimethyl | Alanine | 50/2.6 | 14.78 | 7.76 | 47.5 |
| | oxide(300) | betaine 50) | (150) | | | | |
| | Stearyldimethylamine | Stearyldimethyl | Alanine | 60/2.6 | 14.91 | 7.21 | 51.6 |
| | oxide(300) | betaine(50) | (150) | | | | |
| | Stearyldimethylamine | Stearyldimethyl | Alanine | 70/2.6 | 15.08 | 7.14 | 52.7 |
| | oxide(300) | betaine(50) | (150) | | | | |
| | Stearyldimethylamine | Stearyldimethyl | Alanine | 80/2.6 | 15.34 | 7.54 | 50.8 |
| | oxide(300) | betaine(50) | (150) | | | | |
| | Stearyldimethylamine | Stearyldimethyl | Alanine | 90/2.6 | 15.52 | 7.81 | 49.7 |
| | oxide(300) | betaine(50) | (150) | | | | |
| Example 3 | Stearyldimethylamine | Stearyldimethyl | Alanine | 50/2.6 | 14.78 | 4.27 | 71.1 |
| | oxide(1200) | betaine | (600) | | | | |
| | | (200) | | | | | |
| | Stearyldimethylamine | Stearyldimethyl | Alanine | 60/2.6 | 14.91 | 4.01 | 73.1 |
| | oxide(1200) | betaine | (600) | | | | |
| | | (200) | | | | | |
| | Stearyldimethylamine | Stearyldimethyl | Alanine | 70/2.6 | 15.08 | 3.89 | 74.2 |
| | oxide(1200) | betaine | (600) | | | | |
| | | (200) | | | | | |
| | Stearyldimethylamine | Stearyldimethyl | Alanine | 80/2.6 | 15.34 | 4.09 | 73.3 |
| | oxide(1200) | betaine | (600) | | | | |
| | | (200) | | | | | |
| | Stearyldimethylamine | Stearyldimethyl | Alanine | 90/2.6 | 15.52 | 4.37 | 71.8 |
| | oxide(1200) | betaine(200) | (600) | | | | |

As shown in the above Table 1, it was recognized that Examples 1 to 3 using the present composition had noticeably excellent effects for reducing flow-resistance and, in particular, favorable flow-resistance reduction effects were exhibited even at 90° C. or more from the results obtained dependent on varied temperatures.

### EXAMPLE 4

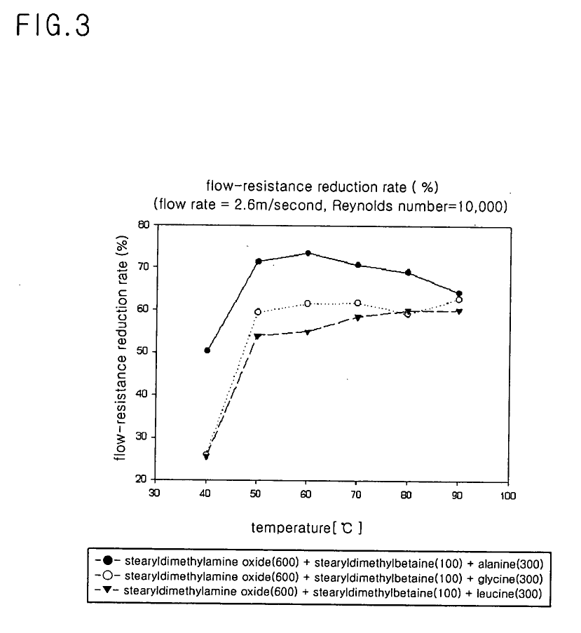

The procedure of Example 1 was repeated except that amino acid was changed to glycine and leucine, to thereby obtain the flow-resistance reduction effect. The results are shown in FIG. 3.

As shown in FIG. 3, it was found that using the present composition resulted in the excellent flow-resistance reduction effect even if the amino acid was varied.

### EXAMPLES 5 TO 8

The procedure of Example 1 was repeated except that test conditions such as circulation rate of circulation water, concentrations of compositions in circulation water, composition ratio, and/or types of compositions were verified as shown in the following Table 2, to thereby obtain the flow-resistance reduction effect. The results are shown in Table 2.

TABLE 2

| | | | | Temperature | | | Flow- |
|---|---|---|---|---|---|---|---|
| | First | Secondary | | (° C.)/ | | | resistance |
| | surfactant | surfactant | Stabilizer | flow | | | reduction |
| | (ppm | (ppm | (ppm | rate | ΔPw | ΔPd | effect |
| Classification | concentration) | concentration) | concentration) | (m/second) | (kPa | (kPa) | (%) |
| Example 5 | Stearyldimethylamine | Stearyldimethyl | Glycine | 70/2.2 | 12.85 | 3.18 | 75.3 |
| | oxide(600) | betaine(100) | (300) | | | | |
| | Stearyldimethylamine | Stearyldimethyl | Glycine | 70/2.6 | 15.08 | 4.02 | 73.3 |
| | oxide(600) | betaine(100) | (300) | | | | |
| | Stearyldimethylamine | Stearyldimethyl | Glycine | 70/3.0 | 19.98 | 5.05 | 74.7 |
| | oxide(600) | betaine(100) | (300) | | | | |
| Example 6 | Stearyldimethylamine | Stearyldimethyl | Glycine | 70/2.6 | 15.08 | 10.91 | 27.6 |
| | oxide(90) | betaine(15) | (45) | | | | |
| | Stearyldimethylamine | Stearyldimethyl | Glycine | 70/2.6 | 15.08 | 5.81 | 61.4 |
| | oxide(300) | betaine(50) | (150) | | | | |
| | Stearyldimethylamine | Stearyldimethyl | Glycine | 70/2.6 | 15.08 | 4.27 | 71.7 |
| | oxide(1200) | betaine(200) | (600) | | | | |
| | Stearyldimethylamine | Stearyldimethyl | Glycine | 70/2.6 | 15.08 | 4.95 | 67.2 |
| | oxide(2400) | betaine(400) | (1200) | | | | |
| | Stearyldimethylamine | Stearyldimethyl | Glycine | 70/2.6 | 15.08 | 7.13 | 52.7 |
| | oxide(3600) | betaine(600) | (1800) | | | | |
| Example 7 | Stearyldimethylamine | Stearyldimethyl | — | 70/2.6 | 15.08 | 7.99 | 47.0 |
| | oxide(600) | betaine(100) | | | | | |
| | Stearyldimethylamine | Stearyldimethyl | Alanine | 70/2.6 | 15.08 | 6.52 | 56.8 |
| | oxide(600) | betaine(100) | (50) | | | | |
| | Stearyldimethylamine | Stearyldimethyl | Alanine | 70/2.6 | 15.08 | 4.08 | 72.9 |
| | oxide(600) | betaine(100) | (300) | | | | |
| | Stearyldimethylamine | Stearyldimethyl | Alanine | 70/2.6 | 15.08 | 7.48 | 50.4 |
| | oxide(600) | betaine(100) | (600) | | | | |
| Example 8 | Stearyldimethylamine | — | Alanine | 70/2.6 | 15.08 | 5.38 | 64.3 |
| | oxide(600) | | (300) | | | | |
| | Stearyldimethylamine | Stearyldimethyl | Alanine | 70/2.6 | 15.08 | 6.05 | 59.9 |
| | oxide(600) | betaine(200) | (300) | | | | |
| | Stearyldimethylamine | Stearyldimethyl | Alanine | 70/2.6 | 15.08 | 6.69 | 55.6 |
| | oxide(600) | betaine(300) | (300) | | | | |
| | Stearyldimethylamine | Stearyldimethyl | Alanine | 70/2.6 | 15.08 | 7.73 | 48.7 |
| | oxide(600) | betaine(600) | (300) | | | | |

As shown in Table 2, it was recognized that Example 5 altering flow rate of the circulation water had excellent effects for reducing flow-resistance independent on the flow rates. And, it was found in Example 6 using varied concentrations of the compositions in the circulation water that the excellent flow-resistance reduction effect was exhibited in case the concentration was within 200 to 5000 ppm. Moreover, the excellent flow-resistance effects were further exhibited in both of the Example 7 with variation of amount of amino acid and the Example 8 with variation of amount of the secondary surfactant.

### COMPARATIVE EXAMPLE 1

The procedure of Example 1 was repeated except that amino acid DL-alanine was replaced by sodium salicylate, sodium dodecylbenzene sulfonate or sodium benzoate well known as non-amino acid stabilizer compounds, to thereby obtain the flow-resistance reduction effect. The results are shown in Table 3.

TABLE 3

| | | | | Temperature | | | Flow- |
|---|---|---|---|---|---|---|---|
| | First | Secondary | | (° C.)/ | | | resistance |
| | surfactant | surfactant | Stabilizer | flow | | | reduction |
| | (ppm | (ppm | (ppm | rate | ΔPw | ΔPd | effect |
| Classification | concentration) | concentration) | concentration) | (m/second) | (kPa | (kPa) | (%) |
| Comparative | Stearyldimethylamine | Stearyldimethyl | Sodium | 70/2.6 | 15.08 | 12.46 | 17.4 |
| Example 1 | oxide(600) | betaine(100) | salicylate | | | | |
| | | | (300) | | | | |
| | Stearyldimethylamine | Stearyldimethyl | Dodecylbenzene | 70/2.6 | 15.08 | 13.19 | 12.5 |
| | oxide(600) | betaine(100) | sulfonate | | | | |
| | | | (300) | | | | |
| | Stearyldimethylamine | Stearyldimethyl | Sodium | 70/2.6 | 15.08 | 11.67 | 22.6 |
| | oxide(600) | betaine(100) | benzoate | | | | |
| | | | (300) | | | | |

As shown in the above Table 3, it was found that using non-amino acid compounds as the stabilizer expressed the flow-resistance reduction effect remarkably lowered, compared to Example 7 using alanine as the stabilizer.

### COMPARATIVE EXAMPLES 2 AND 3

The procedure of Example 1 was repeated except that component ratios of betaine and amine oxide were out of the range according to the present invention or the secondary surfactant was replaced by alkylammonium or sodium dodecylbenzene sulfonate not applicable for the present invention, to thereby obtain the flow-resistance reduction effect. The results are shown in Table 4.

TABLE 4

| | | | | Temperature | | | |
|---|---|---|---|---|---|---|---|
| | First | Secondary | | (° C.)/ | | | Flow- |
| | surfactant | surfactant | Stabilizer | flow | | | resistance |
| | (ppm | (ppm | (ppm | rate | ΔPw | ΔPd | reduction |
| Classification | concentration) | concentration) | concentration) | (m/second) | (kPa | (kPa) | effect(%) |
| Comparative | Stearyldimethylamine | Stearyldimethyl | Alanine | 70/2.6 | 15.08 | 12.67 | 15.98 |
| Example 2 | oxide(100) | betaine(600) | (300) | | | | |
| Comparative | Stearyldimethylamine | Ammonium | Alanine | 70/2.6 | 15.08 | 13.61 | 9.7 |
| Example 3 | oxide(600) | cetyltrimethyl | (300) | | | | |
| | | chloride | | | | | |
| | | (100) | | | | | |
| | Stearyldimethylamine | Sodium | Alanine | 70/2.6 | 15.08 | 14.13 | 6.3 |
| | oxide(600) | dodecylbenzene | (300) | | | | |
| | | sulfonate | | | | | |
| | | (100) | | | | | |

As shown in the above Table 4, it was found that Comparative Example 2 employing concentration ratio of amino acid to the surfactant out of the range according to the present invention expressed the flow-resistance reduction effect lowered. In addition, Comparative Example 3 also exhibited the flow-resistance reduction effect noticeably lowered.

As mentioned above, the present invention is effective to provide the composition for reducing flow-resistance of hot water which is used to efficiently reduce the flow-resistance in a tubular container accompanied in energy transfer using the hot water based fluid at 50 to 100° C., and a process capable of efficiently reducing flow-resistance of the hot water in the tubular container using the same.

More particularly, the composition for reducing flow-resistance according to the present invention comprises an environment-friendly surfactant and natural amino acid component as a micelle structure stabilizer, so that it can minimize possibility of environmental contamination caused by leak of hot fluid and keep toxicity against microorganisms to lower level, and be effective to ensure both of practical usability and compatibility.

While the present invention has been described with reference to exemplary embodiments thereof, it will be understood by those skilled in the art that various changes in form and details may be made therein without departing from the scope of the present invention as defined by the following claims.

1. A composition for reducing flow-resistance of hot water comprising:
alkylamine oxide based surfactant and amino acid based structure stabilizer for stabilizing structure of micelles generated from the surfactant.

2. The composition according to claim 1, wherein the alkylamine oxide based surfactant is selected from compounds represented by the following formula 1: 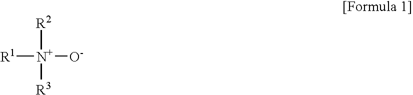
wherein R¹ is alkyl group having 12 to 22 carbon atoms, and R2 and R3 which are same or different are selected from a group consisting of —H, CH₃ and —(CH₂—CH₃—O)ₙ—H wherein n is 1 to 3.

3. The composition according to claim 2, wherein the alkylamine oxide based surfactant represented by the above formula 1 includes any selected from a group consisting of lauryldimethyl amine oxide, myristyldimethyl amine oxide, palmityldimethyl amine oxide, stearyldimethyl amine oxide, arachyldimethyl amine oxide, biphenyldimethyl amine oxide, N,N-diethoxylauryl amine oxide, N,N-diethoxymyristyl amine oxide, N,N-diethoxypalmityl amine oxide, N,N-diethoxystearyl amine oxide, N,N-diethoxyarythyl amine oxide or N,N-diethoxybihenyl amine oxide being used singly or in combination of two or more.

4. The composition according to claim 2, wherein the alkylamine oxide based surfactant is stearyldimethylamine oxide.

5. The composition according to claim 1 wherein the amino acid based structure stabilizer is contained in an amount of 1 to 100 parts by weight based on 100 parts by weight of the alkylamine oxide based surfactant.

6. The composition according to claim 5, wherein the amino acid based structure stabilizer is selected from compounds represented by the following formula 2:
R⁴—(CH₂)ₘ—COOH [formula 2]
wherein R⁴ is alkyl or allyl group bonded with amino functional group (—NH₂) having 1 to 5 carbon atoms, and m is integer ranged from 0 to 5.

7. The composition according to claim 6, wherein the amino acid based compounds represented by the above formula 2 include glycine, alanine, valine, leucine, isoleucine, threonine, serine, cysteine, cystine, methionine, aspartic acid, asparagine, glutamic acid, diodide tyrosine, lysine, arginine, histidine, phenylalanine, tyrosine, tryptophan, proline, oxyproline, α-alanine, -aminobutyric acid, ornithine, citrulline, homoserine, triiodide tyrosine, thyroxine, dioxyphenylalanine, being used singly or in combination of two or more.

8. The composition according to claim 6, wherein the amino acid based compounds with the above formula 2 is selected from alanine, glutamine or glycine.

9. The composition according to claim 5, further comprising a secondary surfactant as a surfactant not generating precipitate by combination with the alkylamine oxide based surfactant.

10. The composition according to claim 9, wherein the secondary surfactant is contained in an amount of 100 parts by weight or less based on 100 parts by weight of the alkylamine oxide based surfactant.

11. The composition according to claim 10, wherein the secondary surfactant includes alkyl polyglucoside ester, polyoxyethylene sorbitane monolaurate, polyoxyethylene sorbitane monostearate, polyoxyethylene sorbitane monooleate, polyoxyethylene sorbitane trilaurate, polyoxyethylene sorbitane tristearate, polyoxyethylene sorbitane trioleate, polyoxyethylene methylglucoside ester, cocoamidopropyl betaine, laurylamidopropyl betaine, disodium lauryl amphodiacetate, disodium cocoamphodiacetate, methyl-1-oleylamide ethyl-3-oleylimidazolium methylsulfate, bis(acyloxyethyl)hydroxyethyl ammonium methosulfate lauryldimethyl betaine, myristyldimethyl betaine, palmityldimethyl betaine, stearyldimethyl betaine, arythyldimethyl betaine, biphenyldimethyl betaine being used singly or in combination of two or more.

12. The composition according to claim 10, wherein the secondary surfactant is selected from a group consisting of bis(acyloxyethyl)hydroxyethyl ammonium methosulfate lauryldimethyl betaine, myristyldimethyl betaine, palmityldimethyl betaine, stearyldimethyl betaine, arythyldimethyl betaine and biphenyldimethyl betaine.

13. A process for reducing flow-resistance of hot water comprising:
introducing a composition for reducing flow-resistance of hot water composed of alkylamine oxide based surfactant and amino acid based structure stabilizer to stabilize structure of micelles generated from the surfactant in a concentration ranged from 200 to 5000 ppm in hot circulation water at a temperature ranged from 50 to 100° C. and circulating the mixed water.

14. The process according to claim 13, wherein the composition for reducing flow-resistance of hot water further comprises a secondary surfactant not generating precipitate by combination with the alkylamine oxide based surfactant.

15. The process according to claim 14, wherein the composition for reducing flow-resistance of hot water contains the amino acid based structure stabilizer in an amount of 1 to 100 parts by weight based on 100 parts by weight of the alkylamine oxide based surfactant and the secondary surfactant in an amount of 100 parts by weight or less based on 100 parts by weight of the alkylamine oxide based surfactant.

16. The process according to claim 13, wherein the alkylamine oxide based surfactant is stearyldimethylamine oxide, the amino acid based compound is selected from alanine, glutamine or glycine, and the secondary surfactant is selected from a group consisting of bis(acyloxyethyl)hydroxyethyl ammonium methosulfate lauryldimethyl betaine, myristyldimethyl betaine, palmityldimethyl betaine, stearyldimethyl betaine, arythyldimethyl betaine and biphenyldimethyl betaine.

17. The composition according to claim 2, wherein the amino acid based structure stabilizer is contained in an amount of 1 to 100 parts by weight based on 100 parts by weight of the alkylamine oxide based surfactant.

18. The composition according to claim 3, wherein the amino acid based structure stabilizer is contained in an amount of 1 to 100 parts by weight based on 100 parts by weight of the alkylamine oxide based surfactant.

19. The composition according to claim 4, wherein the amino acid based structure stabilizer is contained in an amount of 1 to 100 parts by weight based on 100 parts by weight of the alkylamine oxide based surfactant.

20. The process according to claim 14, wherein the alkylamine oxide based surfactant is stearyldimethylamine oxide, the amino acid based compound is selected from alanine, glutamine or glycine, and the secondary surfactant is selected from a group consisting of bis(acyloxyethyl)hydroxyethyl ammonium methosulfate lauryldimethyl betaine, myristyldimethyl betaine, palmityldimethyl betaine, stearyldimethyl betaine, arythyldimethyl betaine and biphenyldimethyl betaine.
